(19) United States
(12) Patent Application Publication
(10) Pub. No.: US 2018/0309863 A1
(43) Pub. Date: Oct. 25, 2018

(54) MOBILE COMMUNICATION DEVICE WITH PROJECTION FUNCTION

(71) Applicant: Dongguan Revolution Product Design Co., Ltd., Dongguan (CN)

(72) Inventor: Yeung Tak Lugee Li, Hongkong (HK)

(21) Appl. No.: 15/809,240

(22) Filed: Nov. 10, 2017

(30) Foreign Application Priority Data
Apr. 19, 2017 (CN) 201710257548.8

(51) Int. Cl. H04M 1/02; H04N 5/225; H04N 9/31

(52) U.S. Cl. CPC H04M 1/0272; H04N 5/2257; H04M 1/0264; H04M 1/0266; H04N 9/3141

(57) ABSTRACT

A mobile communication device with projection function includes a main body, a camera and a projector, a display screen is provided at a front surface of the main body, and both the camera and the projector are configured at a top surface of the main body. If the mobile communication device lies on the table, user can also take pictures by using the camera, without picking up the device. Thus the camera operation is more convenient. Furthermore, since the projector is configured at the top surface of the main body, by which the content in the device can be projected directly without connecting other equipment, as a result, user may show or share their photos or videos at any occasion.

### CROSS-REFERENCE TO RELATED APPLICATIONS

This application claims the benefit of priority to Chinese Invention Application No. 201710257548.8, filed Apr. 19, 2017, which is hereby incorporated by reference in its entirety.

### FIELD OF THE INVENTION

The invention relates to a communication device, and more particularly to a mobile communication device with projection function.

### BACKGROUND OF THE INVENTION

Currently, mobile communication devices such as smart phones or tablet PC, etc., are equipped with many entertainment functions, such as communicating, surfing the Internet, taking pictures and playing games, and the like. However, the devices have no real-time content display function. If user wants to show the photos or videos in the device to others, the device must be passed to others, which is inconvenient. Besides, on the teaching classroom occasion or meeting occasion, the device is connected to other devices to show the photos or videos.

At the other hand, a camera is commonly configured at a back surface of the current mobile communication device, thus the camera operation could only be carried out when the device is picked up, and is failed when the device lies on a flat position.

Therefore, there is a need for providing a mobile communication device with both display function and simpler camera operation.

### SUMMARY OF THE INVENTION

One objective of the present invention is to provide a mobile communication device with both display function and simpler camera operation.

To achieve the above-mentioned objective, the present invention provides a mobile communication device with projection function, which includes a main body, a camera and a projector, a display screen is provided at a front surface of the main body, and both the camera and the projector are configured at a top surface of the main body.

In comparison with the prior art, since the camera is configured at the top surface of the main body, thus if the mobile communication device lies on the table, user can also take pictures by using the camera, without picking up the device. Thus the camera operation is more convenient. Furthermore, since the projector is configured at the top surface of the main body, by which the content in the device can be projected directly without connecting other equipment, as a result, user may show or share their photos or videos at any occasion.

Preferably, the camera and the projector are embedded in the top surface of the main body.

Preferably, the camera and the projector are configured at the main body at an angle, and the angle is adjustable.

Preferably, the main body has a middle portion and two side portions that are thicker than the middle portion, and the camera and the projector are configured in the side portions respectively.

Preferably, the display screen is a curved screen, the side portions are protruded toward a rear of the main body, and a receiving space is formed between the two side portions.

Preferably, a receiving slot is provided at the side portion, and the receiving slot has an opening facing to a bottom of the main body.

Preferably, a battery is installed in the receiving slot.

Preferably, a flash light is provided at the top surface of the main body.

Preferably, an infrared rangefinder sensor and/or an infrared temperature sensor are provided at the top surface of the main body.

Preferably, the mobile communication device is a smart phone.

### BRIEF DESCRIPTION OF THE DRAWINGS

The accompanying drawings facilitate an understanding of the various embodiments of this invention. In such drawings:

FIG. 1 is a perspective view of a mobile communication device with projection function according to the present invention; and

FIG. 2 is another perspective view of a mobile communication device with projection function according to the present invention; and

FIG. 3 is a top view of a mobile communication device with projection function according to the present invention.

### DETAILED DESCRIPTION OF ILLUSTRATED EMBODIMENTS

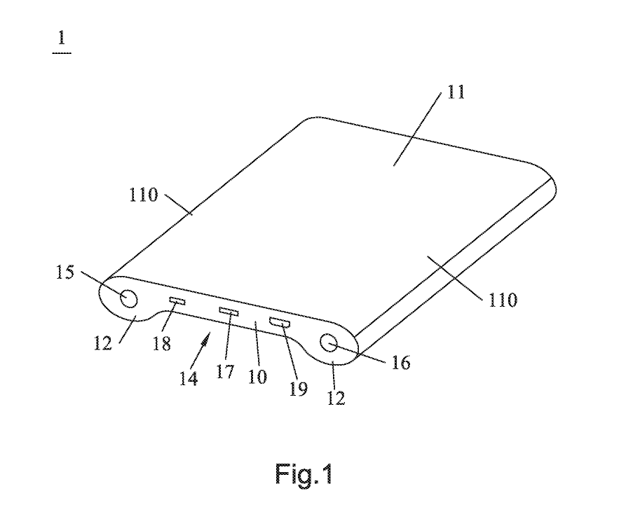

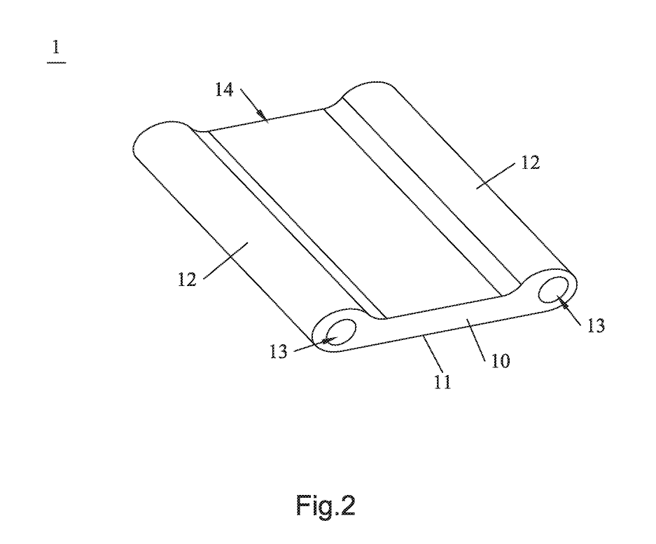

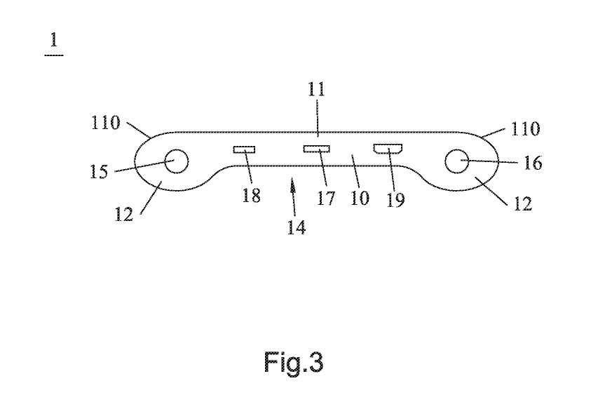

As shown in FIGS. 1-3, a mobile communication device with projection function 1 according to the present invention includes a main body 10, a camera 15 and a projector 16. A display screen 15 is provided at a front surface of the main body 10, two side portions 12 are provided at two sides of the main body, and the thickness of the side portions 12 are larger than that of the middle portion of the main body 10, the side portions 12 are extended form the top surface of the main body 10 to the bottom surface thereof.

The camera 15 and the projector 16 are embedded in the top surface of the main body 10. In such a way, these components can be protected, and the appearance of the mobile communication device 1 is not affected. Specifically, the lens of the camera 15 and the projector 16 are opposite to the bottom surface of the main body 10, so that the device 1 can be projected and shot at the front of the device 1 when the device 1 lies on a flat position. Instead, in the conventional mobile phone, a camera is configured at the back of the mobile phone, thus the structure and function of the camera is limited to use more lens assemblies to achieve high magnification zoom, due to the thickness limitation. In the present device 1, the camera 15 is configured at the side portion 12, that is, the camera 15 is configured along the length direction of the main body that has larger size than the thickness of the device, thus, it's allowable to configure more lens assemblies in the camera 15 to achieve high magnification zoom and better imaging effect. Regarding to the projector 16, it can be chosen according to the actual demand, the smaller size will be better.

Preferably, the camera 15 and the projector 16 are configured at the main body 10 at an angle, and the angle is adjustable. When the camera 15 and the projector 16 are completely embedded in the top surface of the main body 10, the angles of the camera 15 and the projector 16 are adjusted automatically by touching the display screen of the phone. When the camera 15 and the projector 16 are partially protruded from the top surface of the main body 10, their angles can be adjusted manually Specifically, a universal ball joint can be arranged between the camera 15 and the main body 10 or between the projector 16 and the main body 10 to achieve the angle adjustment. Since the angles of the camera 15 and the projector 16 are adjustable, thus the device 1 can capture wider range, and the projector 16 can cover different area even the device 1 is stationary

In this embodiment, the display screen 11 on the main body 10 is a curved screen which has two cambered surfaces 110 at two sides. The side portions 12 are protruded toward the rear of the main body 10, and a receiving space 14 is formed between the two side portions 12. In such a configuration, user may pick up the device 1 easily and quickly, and the receiving space 14 can contain a buckle ring attached on the back of the device, which prevents the buckle ring from installing on or detaching from the device.

Further, the top surface of the main body 10 is provided with a flash light 17, an infrared rangefinder sensor 18 and an infrared temperature sensor 19. Specifically, the flash light 17 is supplied for proving light for the camera 15, or served as an illumination source. Based on the settings of the infrared rangefinder sensor 18 and the infrared temperature sensor 19, the device 1 can measure both of distance and temperature.

Upper portions of the side portions 12 are arranged for installing the camera 15 and the projector 16, and lower portions of the side portions 12 are hollow and provided with receiving slots 13. The receiving slot 13 has an opening facing to the bottom surface of the main body 10. A battery can be installed in the receiving slot 13 to supply power for the projector 16, in such a way, the wastage of the built-in battery of the device 1 is reduced to extend the built-in battery life.

In this present embodiment, the mobile communication device 1 is a smart phone, and can be a tablet PC or other electronic devices in other embodiments.

In comparison with the prior arts, since the camera 15 is configured at the top surface of the main body 10, thus if the mobile communication device 1 is lain on the table, user can also take pictures by using the camera 15, without picking up the device 1. Thus the camera operation is more convenient. Furthermore, since the projector 16 is configured at the top surface of the main body 10, by which the content in the device I can be projected directly without connecting other equipment, as a result, user may show or share their photos or videos at any occasion.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A mobile communication device with projection function, comprising a main body, a camera and a projector, a display screen being provided at a front surface of the main body, and both the camera and the projector being configured at a top surface of the main body, the main body having a middle portion and two side portions that are thicker than the middle portion, a receiving space being formed between the two side portions, and the camera and the projector being configured in the side portions respectively.

2. The mobile communication device according to claim 1, wherein the camera and the projector are embedded in the top surface of the main body.

3. The mobile communication device according to claim 1, wherein the camera and the projector are configured at the main body at an angle, and the angle is adjustable.

4. (canceled)

5. The mobile communication device according to claim 1, wherein the display screen is a curved screen, and the side portions are protruded toward a rear of the main body.

6. The mobile communication device according to claim 1, wherein a receiving slot is provided at the side portion, and the receiving slot has an opening facing to a bottom of the main body.

7. The mobile communication device according to claim 6, wherein a battery is installed in the receiving slot.

8. The mobile communication device according to claim 1, wherein a flash light is provided at the top surface of the main body.

9. The mobile communication device according to claim 1, wherein an infrared rangefinder sensor and/or an infrared temperature sensor are provided at the top surface of the main body.

10. The mobile communication device according to claim 1, wherein the mobile communication device is a smart phone.
